(19) United States
(12) Patent Application Publication
(10) Pub. No.: US 2010/0301996 A1
(43) Pub. Date: Dec. 2, 2010

(54) Nightstand With a Security Safety Drawer

(76) Inventor: Julie Stradiota, Newcastle, CA (US)

Correspondence Address: ITALIA IP, 3500 WEST OLIVE AVE., SUITE 300, BURBANK, CA, 91505, US

(21) Appl. No.: 12/475,750

(22) Filed: Jun. 1, 2009

(51) Int. Cl. G08B 29/00

(52) U.S. Cl. 340/5.53

(57) ABSTRACT

A nightstand with a security safety drawer, that provides for the safe storage of a handgun or firearm while providing convenient and quick access to the handgun or firearm. The nightstand has a structure with an exterior side, a plurality of drawers, a top security drawer for the nightstand to safely and conveniently store the handgun or firearm and a biometric finger scanner to verify and allow the user access to the security top drawer. The nightstand also has a locking device for locking the security top drawer and preventing access to an unauthorized user and a means for providing a primary electrical power source with a battery back-up, to provide a secondary electrical power source to the biometric finger scanner. There is also a portable version of the security safety drawer that can be used in other venues with other nightstands.

### BACKGROUND

This application relates generally to a nightstand with a security safety drawer. More specifically, the application relates to a nightstand with a security safety drawer that can only be opened using a programmed biometric fingerprint scanner. This application also relates to a portable security drawer that can only be opened using a programmed biometric fingerprint scanner.

### SUMMARY

Security, safety and having piece of mind for people is paramount for both individuals and families in these modern and uncertain times. With crime on the rise and local police departments often times being understaffed and overwhelmed, more and more people are turning to ways to defend themselves in the event of an attack, particularly at home. As a result of this, more and more people are turning to defending themselves with handguns and firearms.

The idea of people defending themselves with handguns and firearms is not a simple issue without controversy. Although the Constitution gives American citizens “the right to bear arms”, people who choose to possess firearms and handguns must deal with very serious and potentially life-threatening issues, such as how to keep people untrained in how to properly use a firearm from gaining access to the firearm or handgun and accidentally hurting or even killing themselves. This issue is particularly critical when families with children choose to store and possess handguns or firearms.

Convenience and security are critical for people and particularly families, who choose to possess and store handguns and firearms. Firearm cabinets are very secure, but are not very convenient and readily accessible when going to retrieve a handgun. Ordinary nightstand and cabinet drawers are convenient, but provide no security against persons or children untrained in the use of handguns and firearms. What is needed is a way of safely storing a handgun or firearm while providing convenient and quick access to the handgun or firearm. Such a nightstand or portable drawer that possess these features would be very valuable to people and families who choose to possess and store handguns and firearms in their home or dwelling and would be quite successful in the marketplace.

This application discloses a nightstand with a security safety drawer that provides for the safe storage of a handgun or firearm while providing convenient and quick access to the handgun or firearm. The nightstand has a structure with an exterior side, a plurality of drawers, a top security drawer for the nightstand to safely and conveniently store the handgun or firearm and a biometric finger scanner to verify and allow the user access to the security top drawer. The nightstand also has a locking device for locking the security top drawer and preventing access to an unauthorized user and a means for providing a primary electrical power source, with a battery back-up to provide a secondary electrical power source to the biometric finger scanner.

This application also discloses a portable security drawer to safely and conveniently store a handgun or a firearm for a user. The portable security drawer has an exterior side with a top side and a bottom side and a biometric finger scanner to verify and allow the user to access and open the portable security drawer. The portable security drawer also has a locking device with a release and open mechanism, for locking and unlocking the portable security drawer and preventing access to an unauthorized user and a means for providing a primary electrical power source with a battery back-up as a secondary electrical power source to the biometric finger scanner.

In particular, this application discloses a nightstand with a security safety drawer that provides a safe way of storing a handgun or a firearm.

In particular, this application also discloses a portable security drawer to safely and conveniently store a handgun or a firearm.

### BRIEF DESCRIPTION OF THE DRAWINGS

The drawings, when considered in connection with the following description, are presented for the purpose of facilitating an understanding of the subject matter sought to be protected.

FIG. 1 is an environmental perspective view of a first embodiment of a nightstand with a security safety drawer.

FIG. 2 is a side perspective view of the nightstand with a security safety drawer.

FIG. 3 is a side perspective view of a first embodiment of a portable security drawer.

### DETAILED DESCRIPTION

While the present nightstand with a security safety drawer is described with reference to several illustrative embodiments described herein, it should be clear that the present invention should not be limited to such embodiments. Therefore, the description of the embodiments provided herein is illustrative of the present invention and should not limit the scope of the invention as claimed. In addition, while the following description references a nightstand with a security safety drawer, it will be appreciated that the invention may be any nightstand with a security safety drawer.

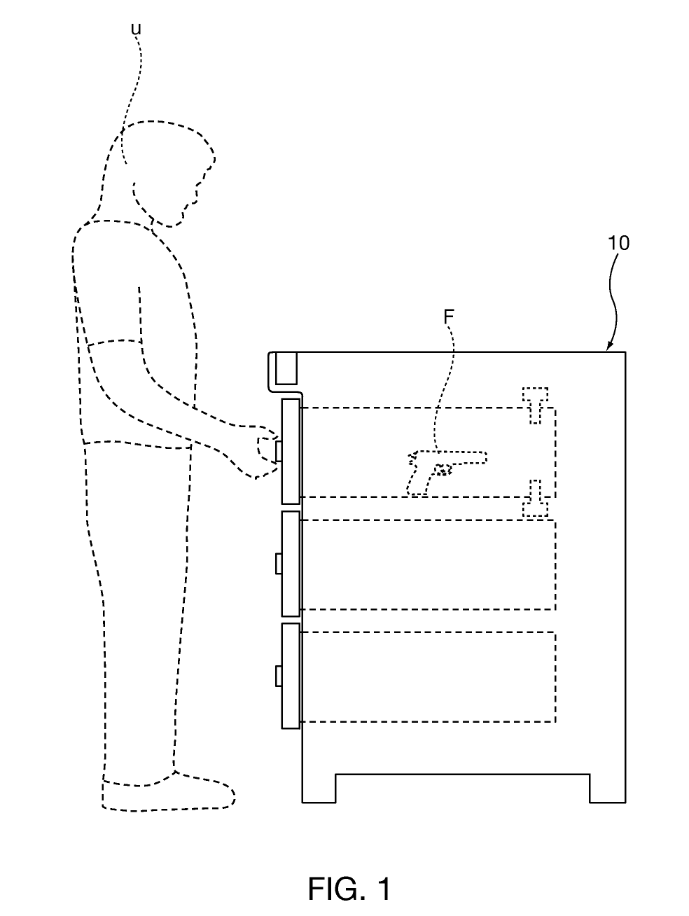

Referring now to FIG. 1, a first embodiment of a nightstand with a security safety drawer 10 being opened by a user U storing a handgun or a firearm F is shown. Firearms F can include other weapons such as machine guns, rifles and shotguns in addition to handguns, but some of these firearms would be too large to physically fit in the nightstand with a security safety drawer 10.

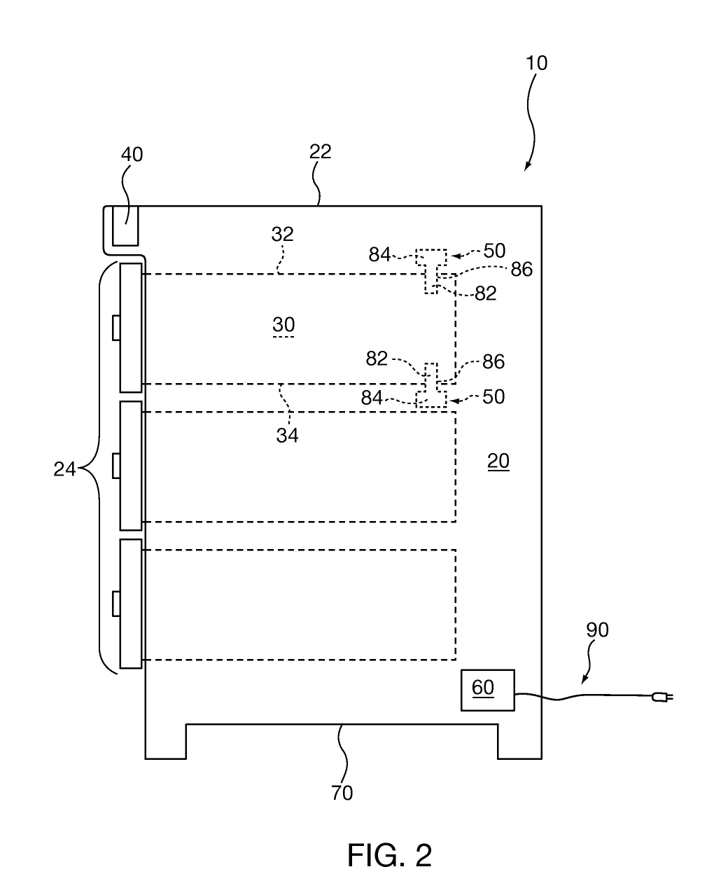

Referring now to FIG. 2, the nightstand with a security safety drawer 10 is made up of a structure 20 with an exterior side 22, a plurality of drawers 24 and a top security drawer 30 with a top side 32 and a bottom side 34, to safely and conveniently store a user's U handgun or firearm F. Note that a user U is defined as a person who can safely utilize a handgun or firearm F either through training or experience or a combination of both, according to those who are well known and schooled in the art. The nightstand with a security safety drawer 10 also has a biometric finger scanner 40 to verify and allow the user U to access and open the top security drawer 30, a locking device with a release and open mechanism 50, for locking and unlocking the top security drawer 30 and preventing access to an unauthorized user U and a means for providing a primary electrical power source, with a battery back-up 60 as a secondary electrical power source to the biometric finger scanner 40.

The structure 20 of the nightstand with a security safety drawer 10 is a plurality of drawers 24 integral to a solid supporting base 70. The top security drawer 30 is the top-most drawer of the plurality of drawers 24 and has a locking device and release and open mechanism 50 on its top side 32 and its bottom side 34. The locking device and release and open mechanism 50 is a protruding and retracting member 82 with a base 84 that protrudes and retracts into an aperture 86 on the top side 32 and the bottom side 34 of the top security drawer 30 for securing and releasing the top security drawer 30. The top security drawer 30 also complies with United States Department of Justice regulatory standards for strength and durability, which are well-known to those schooled in the art.

The nightstand with a security safety drawer 10 also has a biometric finger scanner 40 that is attached to the exterior side 22 of the nightstand with a security safety drawer 10. The biometric finger scanner 40 is calibrated to the user's U fingerprints so that the user U can place his finger onto or into the biometric finger scanner 40 in such a way that the user's U fingerprint can be verified and the top security drawer 30 can be opened. The biometric finger scanner 40 is used to prevent an unauthorized user U from gaining access to a handgun or firearm F stored in the nightstand with a security safety drawer 10. An unauthorized user U is defined by those well known and schooled in the art as an untrained child or adult untrained in safe and proper handgun or firearm F usage. The biometric finger scanner 40 is technology that is well known to those schooled in the art by itself, but is not known to be combined with a nightstand with a security safety drawer 10.

The nightstand with a security safety drawer 10 also has a means for providing a primary power source, which is an AC plug and electric cord 90 leading from the structure 20, that is plugged into a standard electrical outlet (not shown). There is also a battery back-up 60 used in combination with the AC plug and electric cord 90, which provides power to the nightstand with a security safety drawer 10 in the event of a power outage. The battery back-up 60 and AC plug and electric cord 90 are also well known to those schooled in the art.

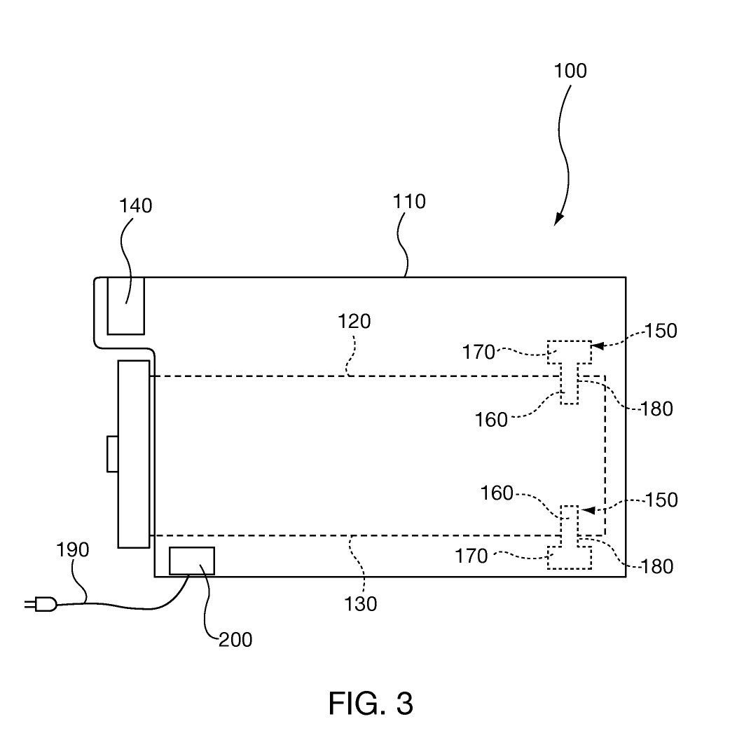

Referring now to FIG. 3, the portable security drawer 100, to safely and conveniently store a handgun or a firearm F for a user U, has an exterior side 110 with a top side 120 and a bottom side 130 and a biometric finger scanner 140 to verify and allow the user U to access and open the portable security drawer 100. The portable security drawer 100 also includes a locking device with a release and open mechanism 150, for locking and unlocking the portable security drawer 10 and preventing access to an unauthorized user U (as defined in FIG. 2) and a means for providing a primary electrical power source with a battery back-up 200 as a secondary electrical power source to the biometric finger scanner 140.

The portable security drawer 100 has locking device with a release and open mechanism 150 on its top side 120 and its bottom side 130. The locking device with a release and open mechanism 150 is a protruding and retracting member 160 with a base 170 that protrudes and retracts into an aperture 180 on the top side 120 and the bottom side 130 of the portable security drawer 100. This is for securing and releasing the top security drawer 100 as desired by the user U. The portable security drawer 100 also complies with United States Department of Justice regulatory standards for strength and durability, which are well-known to those schooled in the art.

The portable security drawer 100 also has a biometric finger scanner 140 that is attached to the exterior side 110 of the portable security drawer 100. The biometric finger scanner 140 is calibrated to the user's U fingerprints so that the user U can place his finger onto or into the biometric finger scanner 140 in such a way that the user's U fingerprint can be verified and the portable security drawer 100 can be opened. The biometric finger scanner 140 is used to prevent an unauthorized user U from gaining access to a handgun or firearm F stored in the portable security drawer 100. An unauthorized user U is an untrained child or adult untrained in safe and proper handgun or firearm F usage, as discussed in FIG. 2. The biometric finger scanner 140 is technology that is well known to those schooled in the art by itself, but is not known to be combined with the portable security safety drawer 100.

The portable security drawer 100, also has a means for providing a primary power source, which is an AC plug and electric cord 190 leading from the portable security drawer 100, that is plugged into a standard electrical outlet (not shown). There is also a battery back-up 200 used in combination with the AC plug and electric cord 190, which provides power to the portable security drawer 100 in the event of a power outage. The battery back-up 200 and AC plug and electric cord 190 are also well known to those schooled in the art.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A nightstand to safely and conveniently allow a user to store a handgun and a firearm, comprising;
a structure with an exterior side, to accommodate and contain a plurality of drawers,
a top security drawer with a top side and a bottom side, to safely and conveniently store said firearm,
a biometric finger scanner to verify and allow said user to access and open said top security drawer,
a locking device with a release and open mechanism, for locking and unlocking said top security drawer and preventing access to an unauthorized user, and
a means for providing a primary electrical power source, with a battery back-up as a secondary electrical power source to said biometric finger scanner.

2. The nightstand according to claim 1, wherein said structure is said plurality of drawers integral to a solid supporting base.

3. The nightstand according to claim 1, wherein said top security drawer has a said locking device and release and open mechanism on its said top side and said bottom side.

4. The nightstand according to claim 1, wherein said top security drawer complies with United States Department of Justice regulatory standards.

5. The nightstand according to claim 1, wherein said biometric finger scanner is attached to said exterior side.

6. The nightstand according to claim 1, wherein said biometric finger scanner is calibrated to said user's fingerprint.

7. The nightstand according to claim 1, wherein said unauthorized user is an untrained child and adult untrained in safe and proper firearm usage.

8. The nightstand according to claim 1, wherein said locking device and release and open mechanism is a protruding and retracting member with a base that protrudes and retracts into an aperture on said top side and said bottom side of said top security drawer for securing and releasing said top security drawer.

9. The nightstand according to claim 1, wherein said means for providing a primary power source is an AC plug and an electric cord leading into said nightstand structure that is plugged into a standard electrical outlet.

10. A portable security drawer to safely and conveniently store a handgun or a firearm for a user, comprising:
an exterior side with a top side and a bottom side,
a biometric finger scanner to verify and allow said user to access and open said portable security drawer,
a locking device with a release and open mechanism, for locking and unlocking said portable security drawer and preventing access to an unauthorized user, and
a means for providing a primary electrical power source with a battery back-up as a secondary electrical power source to said biometric finger scanner.

11. The security drawer according to claim 10, wherein said portable security drawer has said locking device on said top side and said bottom side.

12. The security drawer according to claim 10, wherein said portable security drawer complies with United States Department of Justice regulatory standards.

13. The security drawer according to claim 10, wherein said biometric finger scanner is attached to said exterior side of said portable security drawer.

14. The security drawer according to claim 10, wherein said biometric finger scanner is calibrated to said user's fingerprint.

15. The security drawer according to claim 10, wherein said unauthorized user is an untrained child and an untrained adult in safe and proper firearm usage.

16. The security drawer according to claim 10, wherein said locking device and release and open mechanism is a protruding and retracting member with a base that protrudes and retracts into an aperture on said top side and said bottom side of said portable security drawer for securing and releasing said top security drawer.

17. The security drawer according to claim 10, wherein said means for providing a primary power source is an AC plug and an electric cord leading into said portable security drawer that is plugged into a standard electrical outlet.
